(19) United States
(12) Patent Application Publication
(10) Pub. No.: US 2013/0229703 A1
(43) Pub. Date: Sep. 5, 2013

(54) LENS ARRAY, IMAGE FORMING DEVICE AND METHOD FOR MANUFACTURING LENS ARRAY

(71) Applicant: TOSHIBA TEC KABUSHIKI KAISHA, Tokyo (JP)

(72) Inventors: Atsushi KUBOTA, Shizuoka (JP); Ryozo Akiyama, Shizuoka (JP)

(73) Assignee: Toshiba Tec Kabushiki Kaisha, Tokyo (JP)

(21) Appl. No.: 13/784,441

(22) Filed: Mar. 4, 2013

(30) Foreign Application Priority Data
Mar. 5, 2012 (JP) 2012-048147

(51) Int. Cl. G02B 3/00; B05D 3/06

(52) U.S. Cl. CPC G02B 3/005; B05D 3/067
USPC 359/355; 359/601; 427/558

(57) ABSTRACT

According to one embodiment, a lens array is provided with a plurality of lenses, which are formed in an effective area of a substrate, a dam structure, which is formed in an outer periphery of the plurality of lenses, and light-blocking films, which are formed using an ink and positioned between the plurality of lenses and between the plurality of lenses and the dam structure.

### CROSS-REFERENCE TO RELATED APPLICATION

This application is based upon and claims the benefit of priority from Japanese Patent Application No. 2012-048147, filed Mar. 5, 2012; the entire contents of which are incorporated herein by reference.

### FIELD

Embodiments described herein relate generally to a lens array to which a light-blocking film is provided between a plurality of lenses, an image forming device, and a method for manufacturing a lens array.

### BACKGROUND

Some of the lens arrays used in the optical communication field, the optical disk field, the image display field, and the image transmission and combination field, the optical measurement field, the optical sensing field, and optical processing field, are equipped with a light-blocking film to prevent stray light from entering the lens array. Such lens arrays may be installed in image forming devices including a printer, a copy machine, a multi-function peripheral (MFP), and facsimile, as well as image forming devices including a scanner, multi-image transfer by a liquid display device, solid-state image devices, optical inter connection devices and confocal laser microscopes.

The lens array may be formed as a transparent molded element, therein individual lenses extend from the surface of the element to form the array. The array is positioned in a generally central region of the element, and a peripheral region extends around the lens array for mounting the element within a device where it is to be used. In the lens array, a light-blocking film is formed with an ultraviolet curable ink to cover the transparent regions of the element which do not function as lenses, which ink is cured by ultraviolet light. The ultraviolet curable ink possesses a sufficiently low viscosity to spread naturally into small spaces between lenses. However, the relatively low viscosity of the ultraviolet curable ink may result in the ink spreading outwardly from the lens area and into surrounding areas of the element on which the lens array is formed, such as at the edge of the element, and as a result the thickness of the cured film in the area of the lenses may not be sufficient to block light effectively.

### DESCRIPTION OF THE DRAWINGS

FIG. 1 is a schematic diagram showing an image forming device according to a first embodiment.

FIG. 2 is a schematic diagram showing an image formation device for black (K) according to the first embodiment.

FIG. 3 is a schematic diagram showing an image sensor according to the first embodiment.

FIG. 4 is a schematic top view showing a lens array according to the first embodiment.

FIG. 5 is a schematic illustration showing the lens array according to the first embodiment viewed from the line d-d′ of FIG. 4.

FIG. 6 is a schematic illustration showing a light-blocking film forming device according to the first embodiment.

FIG. 7 is a schematic illustration showing a substrate positioned onto a conveyor bed in a formation process of the light-blocking film according to the first embodiment.

FIG. 8 is a schematic illustration showing discharge of an ultraviolet curable ink in a production process of the light-blocking film according to the first embodiment.

FIG. 9 is a schematic illustration showing irradiation of ultraviolet rays in the production process of the light-blocking film according to the first embodiment.

FIG. 10 is a schematic illustration showing a completed form of the lens array in the production process of the light-blocking film according to the first embodiment.

FIG. 11 is a schematic top view showing a lens array according to a second embodiment.

FIG. 12 is a schematic illustration showing the lens array according to the second embodiment, viewed from the line e-e′ of FIG. 11.

FIG. 13 is a schematic top view showing a lens array according to a third embodiment.

FIG. 14 is a schematic illustration showing the lens array according to the third embodiment, viewed from the line f-f′ of FIG. 13.

FIG. 15 is a schematic illustration showing an alternative example of the lens array of the third embodiment.

### DETAILED DESCRIPTION

Embodiments of the invention provide a method for manufacturing a lens array, an image reading device, and an image forming device and lens array, in which a blocking film is formed thereon with a uniform thickness and provides a quality over the entire lens array area by adequately blocking stray light.

In general, according to one embodiment, a lens array is provided with a plurality of lenses formed on the effective area of a substrate, a dam structure (flow stopper) formed about an outer periphery of the lenses, and a light-blocking film formed using an ultraviolet curable ink which is located between the plurality of lenses, and between the plurality of lenses and the surrounding dam structure.

The embodiments will be explained below with reference to the drawings. Here, the same reference numerals are used for the same components in each drawing.

### First Embodiment

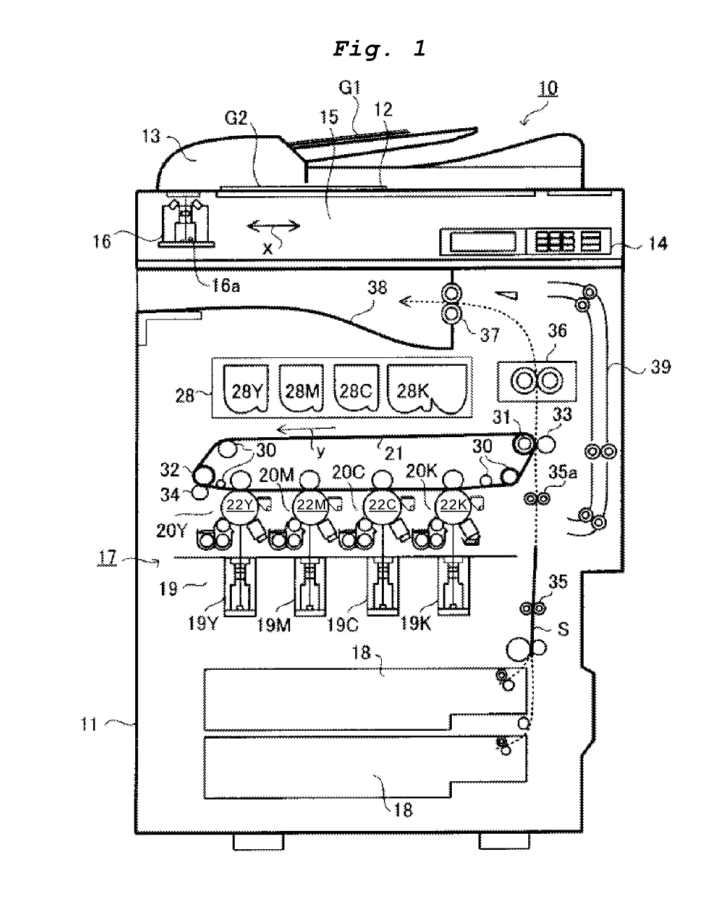

A first embodiment will be explained using FIGS. 1 through 10. FIG. 1 shows color MFP (Multi-Function Peripheral) 10, which is an image forming device according to the first embodiment. There is a platen 12 made of transparent glass on top of a main body 11 of the MFP 10, and an automated document feeder (ADF) 13, which can be opened and closed freely, is installed on top of the platen 12. Also a control panel 14 is installed on the main body 11. The control panel 14 has various keys and a touch panel-type display unit.

A scanner unit 15, which is an image reading device, is installed at the lower part of the ADF 13 inside the main body 11. The scanner unit 15 generates image data by reading an original document G1 sent by the ADF 13, or an original document G2, placed on the platen 12, and is equipped with a close-coupled type image sensor 16a, which is included in the image reading unit. The image sensor 16a is positioned in the main scanning direction (into the paper in FIG. 1). Also, an image reading unit 16 includes a light source. The light emitted from the light source irradiates the original document G2 placed on the platen, and the light reflected by the original document G2 passes the lens array before reaching the image sensor 16a. Also, when reading the image of the document sent by the ADF 13, the image sensor 16a is at the fixed position shown in FIG. 1.

Furthermore, a printer unit 17 is placed at the center inside the main body 11, and at the lower part of the main body 11 are a plurality of cassettes 18 to hold paper of various sizes. The printer unit 17 has a photoreceptor drum and a scanning head 19, which includes an LED as a photographic exposure device, and generates images by scanning photoreceptors using the light from the scanning head 19.

The printer unit 17 generates images on paper by processing image data read by the scanner unit 15, and/or the image data produced by a PC (Personal Computer) and other devices. The printer unit 17 is, for example, a color laser printer by a tandem method, and includes image formation units 20Y (yellow), 20M (magenta), 20C (cyan), and 20K (black) for each color. Image forming units 20Y, 20M, 20C and 20K are arranged in parallel beneath an intermediate transfer belt 21 from the upper side toward the lower side. Also, the scanning head 19 has multiple scanning heads 19Y (yellow), 19M (magenta), 19C (cyan) and 19K (black), which correspond to the image forming units 20Y, 20M, 20C and 20K.

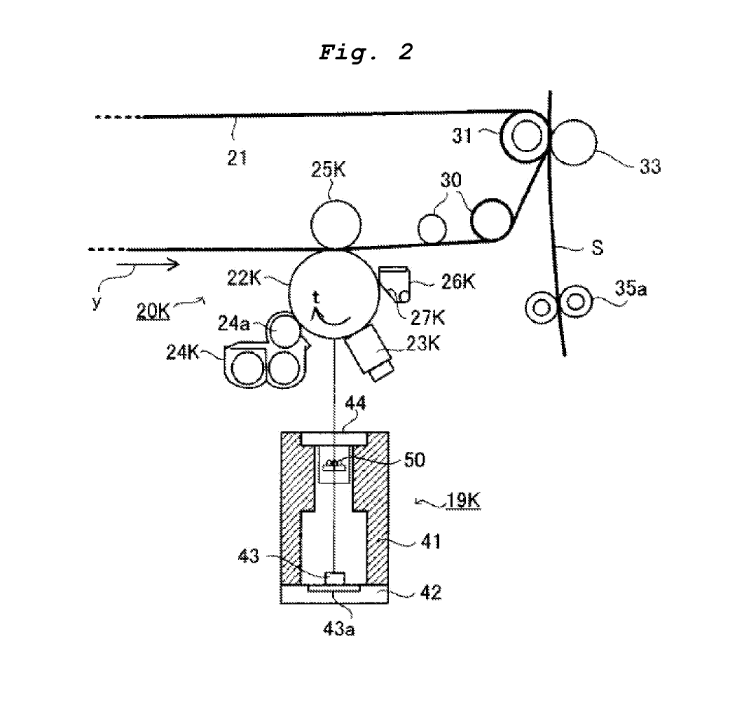

FIG. 2 shows the image formation unit 20K for black (K) among image forming units 20Y, 20M, 20C and 20K. Here, each image forming unit 20Y, 20M 20C and 20K has the same configuration except for the color designation, so the following explanation will be provided using image forming unit 20K as a representative.

The image forming unit 20K has a photoreceptor drum 22K, which is an image support body. Around the photoreceptor drum 22, along a rotation direction t, an electric charger 23K, a developing unit 24K, a primary transfer roller 25K, a cleaner 26K equipped with a blade 27K and others are provided. The scanning head 19K irradiates the photoreceptor drum 22K and forms electrostatic latent images on the photoreceptor drum 22K.

The electric charger 23K of the image forming unit 20K charges the surface of the photoreceptor drum 22K. The developing unit 24K provides photoreceptor drum 22K with black toner through a developing roller 24a to which the developing bias is applied. The cleaner 26K removes residual toner on the surface of the photoreceptor drum 22K using the blade 27K.

As shown in FIG. 1, on the upper part of image formation units 20Y, 20M, 20C and 20K, toner cartridges 28Y, 28M, 28C and 28K are installed to provide each developing unit 20Y, 20M, 20C and 20K with toner. Each of toner cartridges 28Y, 28M, 28C and 28K includes a toner cartridge for its respective color: yellow (Y), magenta (M), cyan (C) and black (K)

The intermediate transfer belt 21 is stretched to a drive roller 31, a driven roller 32, and a tension roller 30, and rotates in the direction of arrow y. Also, the intermediate transfer belt 21 is in contact with and faces photoreceptor drums 22Y, 22M, 22C, and 22K. To the facing position to the photoreceptor drum 22K of the intermediate transfer belt 21, a primary transcription voltage is applied by the primary transfer roller 25K to perform the primary transcription of the toner image on the photoreceptor drum 22K to the intermediate transfer belt 21.

Facing the drive roller 31, which supports the intermediate transfer belt 21, a secondary roller 33 is provided. When sheet S passes between the drive roller 31 and the secondary transfer roller 33, a secondary transfer voltage is applied to the sheet S through the secondary transfer roller 33, and the toner image on the intermediate transfer belt 21 is collectively transcribed secondarily onto sheet S. A belt cleaner 34 is installed near the driven roller 32 of the intermediate transfer belt 21 to clean images from the transfer belt 21.

As shown in FIG. 1, provided between the supply cassette 18 and the secondary transfer roller 33 are a conveyance roller 35, which conveys the sheet S taken from the supply cassette 18, and a resist roller 35a. Further, downstream of the secondary transfer roller 33, a fixing unit 36 is installed. Also, downstream of the fixing unit 36, a sheet ejection roller 37 is installed. The sheet discharge roller 37 ejects the sheet S to a sheet discharge unit 38.

Furthermore, downstream of the fixing unit 36, a reverse conveyor path 39 is provided. The reverse conveyor path 39 reverses and leads the sheet S to the direction of the secondary transfer roller 33, which is used for two-sided copies.

The scanning head 19K shown in FIG. 2 faces the photoreceptor drum 22K. The photoreceptor drum 22K rotates at a pre-set speed, and accumulates electric charge at the surface. Electrostatic latent images are formed at the surface of the photoreceptor drum 22K by irradiating the light from the scanning head 19K onto the photoreceptor drum 22K to expose the photoreceptor drum 22K.

As shown in FIG. 2, the scanning head 19K has a lens array 50, and the lens array 50 is supported by a holding member 41. Also, at the bottom, the holding member 41 has a support body 42, and in the support body 42, an LED element 43 is provided as the light source. The LED element 43 is installed in a straight line at equal intervals in the scanning direction (into the paper). Also, in the support body 42, a control substrate 43a with a driver IC, which controls the irradiation of LED element 43, is provided.

The control substrate 43a generates control signals for the scanning head 19K based on the image data, and causes the LED element 43 to illuminate with a specified intensity according to the control signal. The light emitted from the LED element 43 passes through the lens array 50 and forms images on the photoreceptor drum 22K. The light ray imaged on the lens array 50 forms an electrostatic latent image on the photoreceptor drum 22K. The scanning head 19K is equipped with a cover glass 44 at the upper part (the light emission side).

The image sensor 16a (49) shown in FIG. 3 reads, following the operation of the control panel 14, the image of the original document G2 placed on the platen 12 or the image of the original document G1 supplied by the ADF 13. The image sensor 16 is a primary sensor provided in the scanning direction (into the paper). On the upper surface on the side of platen 12 of a chassis 45 deployed on a substrate 46, two LED line illumination devices 47 and 48, which emit light in the direction of the document, are installed extending in the scanning direction (into the paper). The light source to irradiate the document is not limited to the LED, but can also be a fluorescent tube, a xenon tube, a cold-cathode tube or organic EL and so on.

Between the LED line illumination devices 47 and 48 in the upper part of the chassis 45, the lens array 50 is supported, and on the substrate 46 at the bottom of the chassis 45, a CCD or a CMOS image sensor 49 is provided. The LED line illumination device 47 and 48 irradiates the reading spot for the document image on the platen 12, and the light reflected at the image reading spot enters the lens array 50. The lens array 50 functions as an erecting magnifying lens. The light that enters into the lens array 50 is emitted from the emission side of the lens array 50, and images on the image sensor 49. The imaged light is converted into an electrical signal by the image sensor 49, and is transferred to the memory region of the substrate 46 (not shown in the drawing).

In this embodiment, explanations are made using multi-function peripheral (MFP) as an example of the image forming device. However, the image forming device is not limited to an MFP, but it can be such image reading devices as a stand-alone printer or a stand-alone scanner.

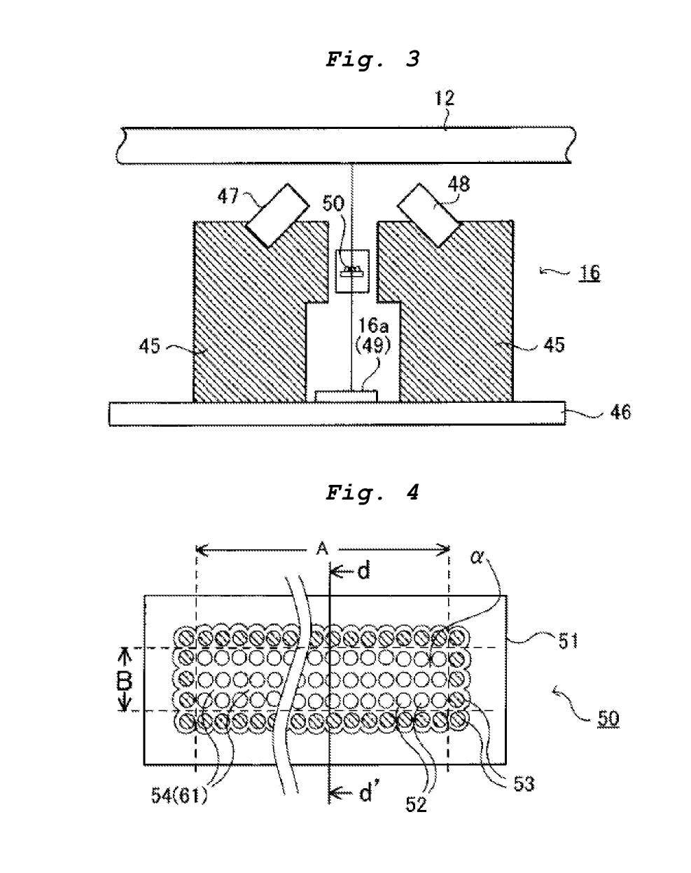

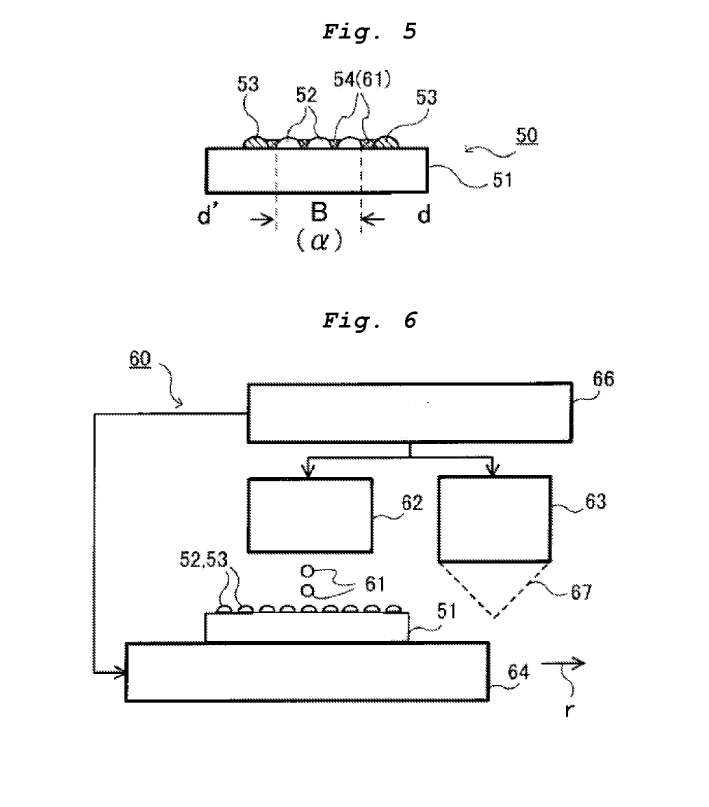

Next, the lens array 50 will be explained. As shown in FIG. 4 and FIG. 5, the lens array 50 is, for example, provided with a plurality of lenses 52 in an effective area α having a length A and width B of a transparent substrate 51. The transparent substrate 51 is also provided with a plurality of dummy lenses 53 (shown with hatched lines) surrounding the lenses 52 in the outer periphery of the lenses 52, which form a dam structure configured to limit flow of ultraviolet curable ink on the transparent substrate 51 prior to the curing thereof. The lens array 50 is provided with, for example, a black light-blocking film 54 with a thickness of 24 μm, formed between lenses 52 and between lenses 52 and the dummy lenses 53. The dummy lenses 53 are, for example, formed in conjunction with lenses 52 by a by molding when the substrate 51 is formed. Each lens 52 and the dummy lens 53 have the same shape, and the space between lenses 52 and the dummy lens 53 is the same as the space between the plurality of lenses 52 in the effective area α of the substrate 51.

The light-blocking film 54 is formed using a light-blocking film forming device 60 as shown in FIG. 6. The light-blocking film forming device 60 forms the light-blocking film 54 by curing with ultraviolet light the ink sprayed by an inkjet method. The light blocking formation device 60 is equipped with an inkjet printing unit 62, an ultraviolet irradiation device 63, a conveyor bed 64 and a control unit 66.

The conveyor bed 64 supports the substrate 51, equipped with the lenses 52 and dummy lenses 53 formed by a metal mold, in a fixed state, and moves the substrate 51 in the direction of arrow r. The conveyor bed 64 transfers the substrate 51 to locations adjacent the inkjet printing unit 62, and the ultraviolet irradiation device 63. The inkjet printing unit 62 discharges an ultraviolet curable ink 61 from above the substrate 51 to the areas between the plurality of lenses 52, surrounded by the dummy lenses 53, and between the lenses 52 and the dummy lenses 53. The ultraviolet irradiation device 63 emits ultraviolet light 67 to the ultraviolet curable ink 61 on the substrate 51. The control unit 66 controls the inkjet printing unit 62, the ultraviolet irradiation device 63 and the conveyor bed 64. The control unit 66, for example, controls the conveyance speed and conveyance timing of the conveyor bed 64. The control unit 66, for example, controls the discharge amount of ink from the inkjet printing unit 62. The control of discharge amount of ink, for example, is conducted by adjusting the voltage used to discharge the ink to adjust the size of the drops, or adjusting the number of drops of the liquid in a multi-drop process. The control unit 66 controls, for example, the wavelength of ultraviolet rays of the ultraviolet irradiation device 63.

Alternatively, the light-blocking film forming device 60 can supply the ultraviolet curable ink 61, not by the inkjet method but by using an ink spreading device. Also, in forming the light-blocking film 54, instead of moving the conveyor bed 64, the inkjet printing unit 62 and the ultraviolet irradiation device 63 can be moved, while the conveyor bed 64 is fixed.

The ultraviolet curable ink will be explained and sample materials for ultraviolet curable ink will be described hereinafter.

### Light Blocking Materials

As the light blocking material for forming light-blocking films between a plurality of lenses, consideration of the optical light blocking properties and the reflective qualities are required. Next, considerations of qualities for an inkjet ultraviolet curable ink such as the flight capability and dispersion stability of the ink are required. For these materials, light absorbing pigments can be employed, for example, carbon-based pigments such as carbon black, refined carbon, carbon nanotube; metallic oxide pigments such as iron black, zinc oxide, titanium oxide, chrome oxide, and iron oxide; sulfide pigments such as zinc sulfide; phthalocyanine-based pigments, such pigments made of salt as metallic sulfate, carbonate, silicate, and phosphate; and metallic powder pigments such as aluminum powder, bronze powder, and zinc powder, can be employed for their light blocking properties.

### Reactive Materials

The fundamental materials for the light-blocking film are photocurable materials, made of reactive materials with a polymeric functional group, which is polymerized by light, such as monomer and oligomer, which are combined with a photoinitiator to trigger the polymerization of the reactive materials. The photocurable materials may be divided into a radical-type and a cation-type of material.

For the radical-type, acrylic monomers and oligomers with an acryloyl functional group are representative, in which the polymerization is promoted by radicals generated by the irradiated photoinitiator. However, there are problems such as oxygen inhibition occurring during the polymerization of these materials, and the reduction of volume after curing is relatively significant, so it has been sought to use it by controlling these shortcomings.

As the cation-type material, there are such cyclic ether compounds exemplified as epoxy and oxetane compounds, and vinyl ether compounds with a vinyl ether group, which initiate the polymerization using electrons generated by the irradiation of the photoinitiator. Among them, cyclic ether compounds have the characteristics of small volume reduction after the polymerization, and therefore have superior adhesion with the underlying base materials once cured. Also, there is a difference from the radical-type in that the polymerization can proceed without causing oxygen inhibition, and the ability to form thin films is superior.

As a light-blocking film for the lens array, taking into consideration the above properties, materials compatible with the ink qualities as the inkjet ultraviolet curable ink can be appropriately chosen for use. For the ink materials of this embodiment, there is no limitation as long as the performance as a light-blocking film, such as the light blocking quality, the reflexive quality, the strength of the curing film, and the ultraviolet curing condition; and physical qualities such as viscosity, surface tension, as an inkjet ultraviolet curable ink, the dispersion stability of the light blocking materials and the compatibility with the head part can be satisfied. In the following, specific examples are listed.

Exemplified as the material of a radical type are, depending on the number having acryloyl groups in the molecule, monomers such as monofunctional acrylate, bifunctional acrylate, tri- or higher polyfunctional acrylate, etc.; and oligomers such as polyester acrylate, urethane acrylate, epoxy acrylate, etc. Of those, the monofunctional monomer is often used as a reactive diluent, and as the inkjet ink, it plays an important role as the material for adjusting viscosity.

As the specific examples, isobornyl acrylate, acryloyl morpholine, dicyclopentadienyl acrylate, acrylic acid adduct of phenyl glycidyl ether; 2-hydroxy ethyl acrylate, 2-hydroxy propyl acrylate, 2-hydroxy butyl acrylate, 2-hydroxy hexyl acrylate, ethyl carbitol acrylate, tetrahydrofurfuryl acrylate, 2-acryloyloxyethyl phthalate, benzyl acrylate; and methacrylic acrylate such as a 2-hydroxyhexyl methacrylate, acryl methacrylate, benzyl methacrylate, and cyclohexyl methacrylate, may be employed.

Exemplified as the bifunctional acrylate are neopentyl glycol diacrylate, nonanediol diacrylate, tripropylene glycol diacrylate, tricyclodecane dimethanol diacrylate, EO adduct acrylate of bisphenol A and so on; and exemplified as the polyfunctional acrylates such as trimethylolpropane triacrylate, pentaerythritol triacrylate, dipentaerythritol pentaacrylate, triacrylates of isocyanuric acid EO adduct, and so on. Other than those of acrylate-base, N-vinyl pyrrolidone, N-vinyl caprolactam and so on are also useful as diluents.

As cation-type materials, epoxy compounds, oxetane compounds, vinyl ether compounds and so on can be used.

Examples of the epoxy compounds include the compounds having an epoxy group or an alicyclic epoxy group, which is present on either or both of a hydrocarbon group having a bivalent aliphatic skeleton or an alicyclic skeleton and a bivalent group having an aliphatic chain or an alicyclic skeleton in a portion thereof. For example, it is possible to employ alicyclic epoxy such as Celloxide 2021, Celloxide 2021A, Celloxide 2021P, Celloxide 2081, Celloxide 2000, and Celloxide 3000 manufactured by Daicel Chemical Industries, Ltd.; Cyclomer A200, Cyclomer M100, which are (meth)acrylate compounds having an epoxy group; methacrylate having a glycidyl methyl group such as MGMA; glycidol, which is a low molecular epoxy compound; β-methyl epichlorohydrin; α-pinene oxide, α-olefin monoepoxide having 12 to 14 carbon atoms; α-olefin monoepoxide having 16 to 18 carbon atoms; epoxidized soy bean oil such as Daimac S-300K; epoxidized linseed oil such as Daimac L-500; and polyfunctional epoxy compounds such as Epolead GT 301 and Epolead GT401.

Moreover, it is also possible to use alicyclic epoxy, such as Cylacure, product of Dow Chemical Co., Ltd, U.S.; low molecular weight phenol compounds that are hydrogenated and aliphatized with terminal hydroxyl group thereof being substituted by a group having epoxy; glycidyl ether compounds such as polyhydric aliphatic alcohols/alicyclic alcohols such as ethylene glycol and glycerol, neopentyl alcohol and hexanediol, trimethylolpropane; and glycidyl esters of hexahydrophthalic acid or hydrogenated aromatic polyhydric carboxylic acid.

Exemplified as the oxetane compounds are, for example, compounds in which more than one oxetane-containing groups are introduced to alicyclic such as (di[1-ethyl(3-oxetanol)]methyl ether, 3-ethyl-3-(2-ethylhexyloxy methyl)oxetane, [(1-ethyl-3-oxyetanol)methoxy]cyclohexane, bis[(1-ethyl-3-oxetanol)methoxy]cyclohexane, bis[(1-ethyl-3-oxetanol)methoxy]norbonane; ether compounds in which oxetane-containing alcohols such as 3-ethyl-3-hydroxymethyl oxetane is dehydrated and condensed to aliphatic polyhydric alcohols such as ethylene glycol, propylene glycol, neopentyl alcohols or the like. In addition, exemplified as the oxetane compounds that contain aromatic skeletons are, for example, 1,4-bis((1-ethyl-3 oxetanil)methoxy)benzene, 1,3-bis((1-ethyl-3 oxetanil)methoxy)benzene, 4,4′-bis((3-ethyl-3 oxetanil)methoxy)biphenyl, phenol novolac oxetane, or the like.

Exemplified as the vinyl ether compounds are 2-ethylhexylvinylether, butadiol divinyl ether, cyclohexanedimethanol divinyl ether, cyclohexanedimethanol monovinyl ether, diethylene glycol monovinyl ether, diethylene glycol divinyl ether, hexanediol divinyl ether, triethylene glycol divinyl ether, 4-hydroxybutyl vinyl ether, or the like. When decrease in viscosity and improvement in the degree of hardness in terms of curing are required, in addition to the improvement in the curing rate, it is preferred to blend alone or in combination the vinyl ether compounds expressed by the following formula (I) in a liquid ink.

Because of noticeable inhibition of polymerization by pigment in the vinyl ether compound bonded with a methylene group such as aliphatic glycol derivatives and cyclohexanedimethanol, it has been difficult to use this combination as an ink to date. However, as shown in the following formula (1), the compound in which a vinyl ether group directly having an alicyclic skeleton, a terpenoid skeleton, or an aromatic skeleton has excellent curing performances even when it has a pigment. The proportion of the compound may be 50 parts by weight, or less, to maintain the thermoplastic property of the liquid ink. When greater solvent resistance and hardness are required, the proportion may be further increased to the entire quantity of the solvent to be cured by acid, even though some degradation in the thermoplastic property may occur.

R13-R14-(R13)p Formula (1)

In the formula (I) above, for R13, at least one represents vinyl ether group, and it represents a substituent selected from a vinyl ether group and a hydroxyl group. R14 is a (p+1) valent group selected from an alicyclic skeleton or a skeleton having an aromatic ring, and p represents a positive integer including 0. However, when R14 is a cyclohexane ring skeleton and p is 0, at least one carbon on the ring has a ketone structure. Exemplified as the organic group R14 of (p+1) valent are, for example, (P+1) valent groups containing a benzene ring, a naphthalene ring, a biphenyl ring; (P+1) valent group to be derived from a cycloalkane skeleton, a norbornane skeleton, a adamantane skeleton, a tricyclodecane skeleton, a tetracyclododecane skeleton, a terpenoid skeleton, and a cholesterol skeleton.

To be precise, it is also possible to use a compound in which the hydrogen atom of the hydroxyl group in phenol derivatives as well as cycloaliphatic polyol such as cyclohexane (poly)ol, norbornane (poly)ol, tricyclodecane (poly)ol, adamantane (poly)ol, benzene (poly)ol, naphthalene (poly) ol, anthracene (poly) ol, biphenyl (poly) ol, or the like has been substituted with a vinyl group. In addition, exemplified is also a compound in which the hydrogen atom of the hydroxyl group in the polyphenol compound such as polyvinyl phenol, phenol novolac, etc. has been substituted with a vinyl group. The compounds mentioned above are desirable because the volatility will be reduced even when a portion of the hydroxyl group remains, and even when a portion of the methylene atoms of an alicyclic skeleton has been substituted with a ketone group. In particular, since the cyclohexyl monovinyl ether compound is highly volatile, it is preferred to oxidize the cyclohexane ring to at least a cyclohexanone ring when using the cyclohexyl monovinyl ether compound.

Next, as examples of the photoinitiator, there are a radical system and a cationic system. General examples will be listed.

For radical type, there are benzoin ethers, acetophenones, phosphine oxides; for example, a cleavage type such as 1-hydroxycyclohexylphenylketone, diethoxyacetophenone, 2-hydroxy-2-methyl-1-phenylpropane-1-on, 2-benzyl-2-dimethylamino-1-(4-morpholinophenyl)-butanone-1, or the like; a hydrogen abstraction type such as benzophenone, 2,4-diethyl thioxanthone, isopropyl thioxanthone, or the like.

It is possible to use the following as the cationic type: onium salts, diazonium salts, quinone diazide compounds, organic halide, aromatic sulfonate compounds, bisulphone compounds, sulfonyl compounds, sulfonate compounds, sulfonium compounds, sulfamide compounds, iodonium compounds, sulfonyl diazomethane compound, and mixtures thereof.

More specifically, exemplified are triphenyl sulfonium triflate, diphenyl iodonium triflate, 2,3,4,4-tetrahydroxy benzophenone-4-naphthoquinone diazide sulfonate, 4-N-phenyl-amino-2-methoxyphenyl diazonium sulfate, 4-N-phenylamino-2-methoxyphenyl diazonium-p-ethyl phenyl sulfate, 4-N-phenylamino-2-methoxyphenyl diazonium 2-naphthylsulphate, 4-N-phenylamino-2-methoxyphenyl diazonium phenyl-sulfate, 2,5-diethoxy-4-N-4′-methoxyphenyl carbonyl phenyl diazonium-3-carboxy-4-hydroxyphenyl sulfate, 2-methoxy-4-N-phenyl phenyl diazonium-3-carboxy-4-hydroxyphenyl sulfate, diphenyl sulfonyl methane, diphenyl sulfonyl diazomethane, diphenyl sulfone, α-methyl benzoin tosylate, pyrogallol trimesylate, benzoin tosylate, or the like.

The ultraviolet curable ink 61 uses these materials, and, after going through processes, in which (light blocking materials) are dispersed into (reactive monomers), and the obtained dispersed liquid, appropriate monomers, oligomers, the photoinitiator, and as necessary, a polymerization inhibitor are stirred in, and the mixture is filtered or centrifuged to separate rough particles and unnecessary solid contents from the mixture.

In the polymerization inhibitor, there are the one in case of cationic type, and the one in case of radical type. In the case of cationic type, exemplified are n-hexylamine, dodecylamine, aniline, dimethylaniline, diphenylamine, triphenylamine, diazabicyclooctane, diazabicycloundecane, 3-phenyl-pyridine, 4-phenyl pyridine, lutidine, 2,6-di-t-butyl pyridine, or the like. In the case of radical type, exemplified are DPPH (1,1-diphenyl-2-picrylhydrazyl), TEMPO (2,2,6,6-tetramethylpiperydinyl-1-oxyl), p-benzoquinone, chloranil, nitrobenzene, hydroquinone (HQ), methyl hydroquinone (MEHQ), t-butyl catechol, dimethylaniline, or the like.

As the physical property of ultraviolet curable ink 61, if an average molecule diameter of the light blocking materials is set to be 300 nm or less, the flight ability of the inkjet printing unit 62 is not influenced. Also, it is preferable to set the viscosity of the ultraviolet curable ink 61 to 5-30 mPa·s at 25° C., and the surface tension to be within the range of 22-40 mN/m. The viscosity or the surface tension value of the ultraviolet curable ink 61 can be set by blending monomer, oligomer or a surfactant.

Further, in order to let the ink flow naturally into the narrow portion between the substrate 51 and each lens 52, the contact angle of the substrate 51 and the ultraviolet curable ink 61 may be 20 degrees or less at 250C.

The production method to form the light-blocking film 54, which uses ultraviolet curable ink 61, in the area surrounded by the dummy lenses 53 of the substrate 51, will be explained using FIGS. 7 through 10. For the ultraviolet curable ink 61 used for the light-blocking film 54, for example, carbon black is used as a light blocking material. The content of carbon black in the ultraviolet curable ink 61 is set to be 3.5 wt %, the light-blocking film 54 is formed with a thickness of 24 μm. The ultraviolet rays 67, irradiated from the ultraviolet irradiation device 63 is set to have, for example, an irradiance of 2000 mW/cm², a density of 400 mJ/cm², and a wavelength of 365 nm.

The greater the light blocking property is, the more stray light the light-blocking film 54 of the lens array 50 can shield, so it is more advantageous as the property of lens array 50. The light blocking property of light-blocking film 54 can be obtained by, for example, measuring the optical density (transmission density). The optical density, for example, can be measured using 361T densitometer manufactured by X-rite. If the optical density is 6 or greater, the light-blocking film 54 can block light almost completely (the optical density is a logarithm with 10 as the most opaque, and the greater the amount of light reduction is, the greater the value becomes. When the optical density is 6, the transmittance of light is 1/1,000,000%.)

When carbon black is used as a light blocking material for the light-blocking film 54, with the carbon black content for 3.5 wt %, a sufficient light blocking capability can be obtained if the thickness of light-blocking film 54 is about 24 μm or greater. With the carbon black content of 7.5 wt %, a sufficient light blocking capability can be obtained if the thickness of the light-blocking film 54 is about 12 μm or greater. In order to obtain the light-blocking film 54 with sufficient light blocking property, the thickness of the light-blocking film 54 can be increased, or the weight ratio of the light blocking material in the ultraviolet curable ink 61 can be increased.

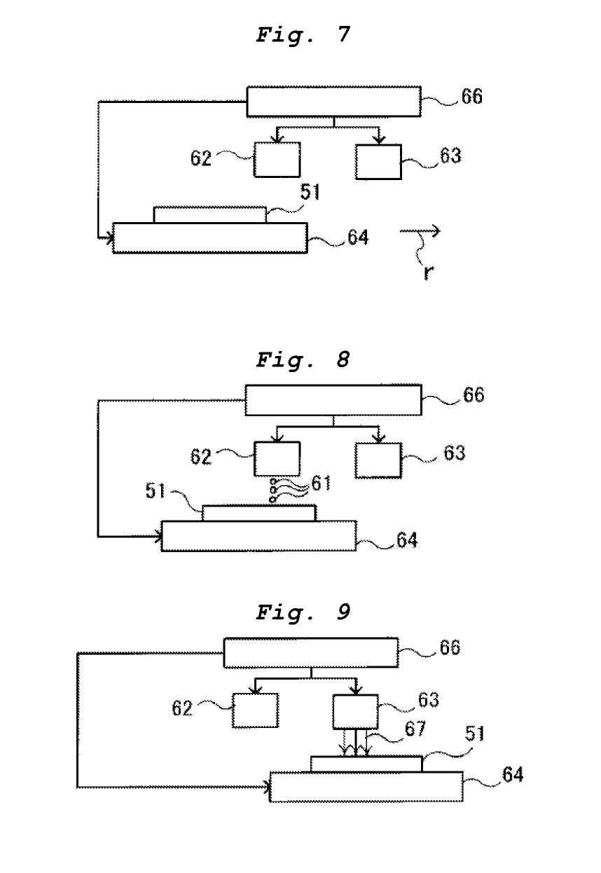

As shown in FIG. 7, the substrate 51, having the lenses 52 and 53 disposed thereon, is fixed on the conveyor bed 64, and the conveyor bed 64 is moved in the direction of arrow r relative to the inkjet printing unit 62 and the ultraviolet irradiation device 63. As shown in FIG. 8, when the substrate 51 reaches the inkjet printing unit 62, the inkjet printing unit 62 discharges the ultraviolet curable ink 61 from above the substrate 51. The ultraviolet curable ink 61 flows to the areas between the plurality of lenses 52, surrounded by dummy lenses 53 of the substrate 51 (shown in FIG. 4), and between the lenses 52 and the dummy lenses 53. The ultraviolet curable ink 61, discharged from the inkjet printing unit 62, spreads in a uniform thickness in the area surrounded by the dummy lenses 53 between the plurality of lenses 52, and between the lenses 52 and the dummy lenses 53, before the substrate 51 reaches the ultraviolet irradiation device 63.

As shown in FIG. 9, when the substrate 51 reaches the ultraviolet irradiation device 63 as the conveyor bed 64 moves in the direction r, the ultraviolet irradiation device 63 irradiates the ultraviolet curable ink 61 with ultraviolet rays 67 from above the substrate to cure ultraviolet curable ink 61. After the substrate 51 passes the ultraviolet irradiation device 63, the ultraviolet curable ink 61 on the substrate 51 is cured. As shown in FIG. 10, when the substrate 51 passes the ultraviolet irradiation device 63, a lens array 50 with the light-blocking film 54 formed between the plurality of lenses 52, surrounded by the dummy lenses 53, and between the lenses 52 and the dummy lenses 53, is produced.

By using the dummy lenses 53 formed on the substrate 51, the same conditions in the effective area α of the substrate (shown in FIG. 4) can be maintained when forming the light-blocking film 54 because the dummy lenses form a dam or weir preventing the ink from spreading over the entire substrate, so that the in finds a natural level within the perimeter of the dummy substrates to a depth based on the volume of ink dispensed. Thus, the area between the lenses 52 and the dummy lenses 53, and in the area surrounded by the dummy lenses 53 of the substrate 51, the light-blocking film 54 with a uniform thickness of 24 μm can be obtained. The light blocking property of the light-blocking film 54 of the lens array 50 is the same in the effective area α of the substrate 51 and in the area around lenses 52 at the edge of the effective area α of the substrate 51, and the light blocking property having an optical density of 6 was obtained.

Here, the lens array 50 has a plurality of lenses 52 provided on one major side of the substrate 51, but the lens array can have a plurality of lenses provided on both major sides of the substrate.

According to the first embodiment, the dummy lenses 53 are formed surrounding the lenses 52 of the substrate 52, and the light-blocking film 54, formed from the ultraviolet curable ink, is formed in an area surrounded by the dummy lenses 53. The lens array 50 has the light-blocking film 54 that has a uniform film thickness on the inside the effective area α, and around the lenses 52 of the edge portion of the effective area α, enabling the light-blocking film 54 to block stray light at the edge portion of the effective area α, and produces a high quality lens array 50 having uniform properties across the entire surface.

### Second Embodiment

Next, a second embodiment will be explained. In the second embodiment, the light-blocking film is formed by supplying the ultraviolet ink inside a wall surrounding the lenses of the substrate. In the second embodiment, for the same configuration explained in the first embodiment, similar reference numerals are used and detailed explanations are omitted for brevity.

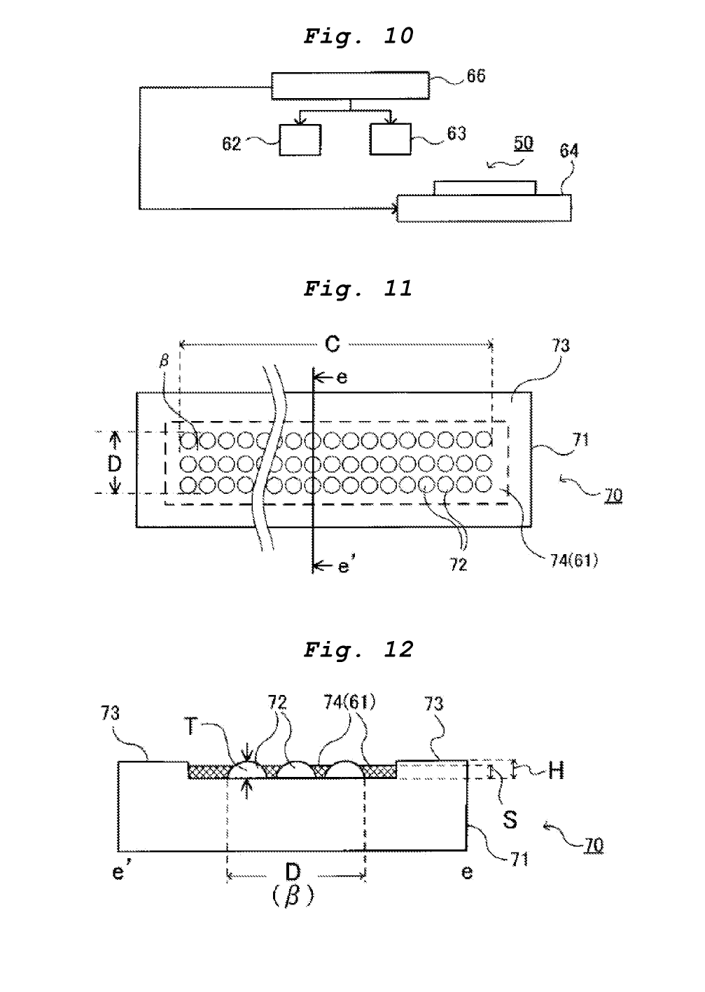

As shown in FIG. 11 and FIG. 12, a lens array 70 according to the second embodiment is provided with, for example, a plurality of lenses 72 are disposed on a transparent substrate 71 in an effective area β with a length C and a width D. A sidewall 73 is formed on the transparent substrate 71 on the outer periphery of the lenses 72. The sidewall 73 surrounds the lenses 72, which is a dam structure according to this embodiment. The lens array 70 is provided with, for example, a black light-blocking film 74 with a thickness of 24 μm, formed between the lenses 72, and between the lenses 72 and the sidewall 73. The outer periphery of the sidewall 73 extends to the outer periphery of the substrate 71, and is formed together with the lenses 72 in a mold, for example, when the substrate 71 is formed. A Height H of the sidewall 73 from a lens formation surface of the substrate 71 (bottom surface of the volume formed between the sidewall 73) is set to be higher than a height S of the light-blocking film 74. The Height H of the sidewall 73 is set, for example, to be higher than a height T of the lenses 72, so it becomes possible to prevent contact between the lenses 72 and an overlying object during handling the lens array 70. For example, if another lens array is placed on top of the lens array 70, the lenses 72 will not contact the other lens array, which prevents damage of the lenses 72.

At the time of forming the light-blocking film 74, the inkjet printing unit 62 (shown in FIG. 8) discharges the ultraviolet curable ink 61 inside the sidewall 73 of the substrate 71. The ultraviolet curable ink 61, discharged from the inkjet printing unit 62, spreads with a uniform thickness between a plurality of lenses 72, and between the lenses 72 and the sidewall 73, inside the sidewall 73, before the substrate 71 reaches the ultraviolet irradiation device 63 (shown in FIG. 9). While the substrate 71 is passing through, the ultraviolet irradiation device 63 irradiates the ultraviolet rays 67 to the inside of the sidewall 73 to cure the ultraviolet curable ink 61, and forms the light-blocking film 74 inside the sidewall 73.

In the area surrounded by the sidewall 73 of the substrate 71, a light-blocking film 74 with adequate light blocking properties, for example a light blocking film with a uniform thickness of 24 μm can be obtained. The light blocking property of the light-blocking film 74 of the lens array 70 is the same in the effective area β of the substrate 71 and in the area around the lenses 72 at the edge of the effective area β of the substrate 71, and the light blocking property having an optical density of 6 is obtained.

Here, the height of the sidewall 73 is not restricted as long as the level of the ultraviolet curable ink 61 deposited by the inkjet printing unit 62 can be regulated.

In the second embodiment, the sidewall 73 is formed around the lenses 72 of the substrate 71, and the light-blocking film 74, made of the ultraviolet curable ink 61, is formed in the area surrounded by the sidewall 73. As in the case of the first embodiment, the lens array 70 can obtain the light-blocking film 74 with a uniform thickness in the area around the lenses 72 at the edge of the effective area β as in effective area β, can shield stray light at the edge of the effective area β, and can obtain uniform lens quality over the entire surface.

### Third Embodiment

Next, a third embodiment will be explained. In the third embodiment, the light-blocking film is formed by providing the ultraviolet curable ink inside a sidewall with a specified width surrounding the lenses of the substrate. In the third embodiment, for the same configuration explained in the first embodiment, the same reference numerals are used and detailed explanations are omitted for brevity.

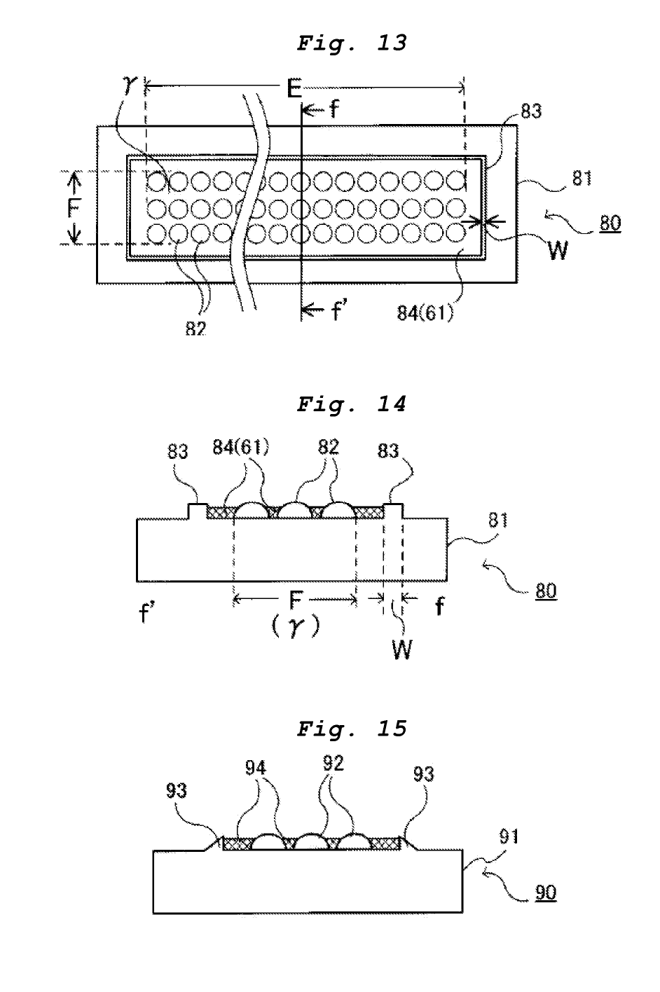

As shown in FIG. 13 and FIG. 14, a lens array 80 according to the third embodiment is provided with, for example, a plurality of lenses 82 in an effective area γ of a transparent substrate 81, with a length E and a width F, and a ridge 83. The ridge 83 is formed in the outer periphery of the lenses 82, and surrounds the lenses 82, and has a width W, which is a dam structure according to this embodiment. The lens array 80 is provided with, for example, a black light-blocking film 84 with a thickness of 24 μm, formed between the lenses 82, and between the lenses 82 and the ridge 83.

Each lens 82, for example, is formed together with the substrate 81 by a metallic mold. The ridge 83 is formed, after the formation of the substrate 81, by discharging ink to the outer periphery of the lens 82 by, for example, the inkjet method. The ink to form the ridge 83 is not limited to the ultraviolet curable ink. Solid ink, liquid ink, and other inks can also be used. Here, the ridge 83 can also be formed with the lens 82 when it is molded in a mold, for example, while the substrate 81 is being formed.

At the formation of the light-blocking film 84, the ultraviolet curable ink 61 is discharged inside the ridge 83 by the inkjet printing unit 62 (shown in FIG. 8), the ultraviolet curable ink 61 is cured by the ultraviolet irradiation device 63 (shown in FIG. 9) irradiating ultraviolet rays 67, and the light-blocking film 84 with a uniform film thickness of 24 μm is formed inside the ridge 83. With area in the effective area γ of the substrate 81 and the area around the lens 82 at the edge of the effective area γ of the substrate 81, the lens array 80, provided with the light-blocking film 84, which has the uniform light blocking property having an optical density of 6, is obtained.

Here, the shape of the ridge is not restricted, and for example, as shown in another example in FIG. 15, the upper part of a sidewall 93 surrounding lenses 92 of a substrate 91 of a lens array 90 can be formed in a taper (an acute angle). The lens array 90 forms a light-blocking film 94 inside the sidewall 93. Also, the height of the sidewall is not restricted. For example, one is free to set the height of the sidewall to be the same as the thickness of the light-blocking film if the ultraviolet curable ink is to be dispersed inside the sidewall by rotating the substrate using a spin coat method, instead of the inkjet method.

In the third embodiment, the light-blocking film 84 made with the ultraviolet curable ink 61 is formed in the area surrounded by the ridge 83 of the lens 82 of the substrate 81. As in the first embodiment, the lens array 80 can obtain the light-blocking film 84 with the same film thickness around the lens 82 at the edge of the effective area γ as in the effective area γ, making it possible to block stray light at the edge of the effective area γ. A uniform lens quality can be obtained over the entire area of the lens array 80.

According to at least one of the embodiments discussed above, it is possible to obtain light-blocking films that have a uniform film thickness around the lenses, as well as at the edges of the lenses, by forming a dam structure around a plurality of lenses in the lens array and providing the ultraviolet curable ink inside the dam structure.

This disclosure is not limited to the above embodiments; various alterations are possible. For example, the alignment and the shape of lenses and so on are optional.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A lens array, comprising:
a plurality of lenses formed on an effective area of a substrate;
a flow restricting structure formed about an outer periphery of the plurality of lenses; and
a light-blocking film comprising an ink provided between the plurality of lenses within the periphery of the flow restricting structure.

2. The lens array according to claim 1, wherein
the flow restricting structure is a plurality of dummy lenses formed on the outer periphery of the lenses.

3. The lens array according to claim 2, wherein
the lenses and the dummy lens have the same shape.

4. The lens array according to claim 1, wherein
the flow restricting structure is a continuous wall that surrounds the outer periphery of the lenses.

5. The lens array according to claim 4, wherein
the wall extends from the outer periphery of the lenses to a periphery of the substrate.

6. The lens array according to claim 4, wherein
the wall is tapered at an acute angle.

7. A lens array, comprising:
a plurality of lenses formed on an effective area of a substrate;
a flow restricting structure formed about an outer periphery of the plurality of lenses; and
a light-blocking film comprising an ultraviolet curable ink provided between the plurality of lenses within the periphery of the flow restricting structure.

8. An image forming device, comprising:
a scan head having a light source that emits light through a lens array, the lens array comprising:
a plurality of lenses formed on an effective area of a substrate;
a flow restricting structure formed on an outer periphery of the plurality of lenses; and
a light-blocking film comprising an ultraviolet curable ink provided between the plurality of lenses within the flow restricting structure.

9. The image forming device according to claim 8, wherein
the flow restricting structure is a plurality of dummy lenses formed to surround the outer periphery of the lenses.

10. The image forming device according to claim 9, wherein
the lenses and the dummy lens have the same shape.

11. The image forming device according to claim 8, wherein
the flow restricting structure is a wall that surrounds the outer periphery of the lenses.

12. The image forming device according to claim 11, wherein
the wall extends from the periphery of the lenses to a periphery of the substrate.

13. The image forming device according to claim 11, wherein
the wall is tapered at an acute angle.

14. A method for manufacturing a lens array, comprising:
forming a flow restricting structure on an outer periphery of a plurality of lenses on a substrate;
flowing an ultraviolet curable material in a volume formed within the flow restricting structure, and in between each of the plurality of lenses; and
curing the ultraviolet curable material with ultraviolet light.

15. The method according to claim 14, wherein
the plurality of lenses are formed on the substrate and the flow restricting structure is formed simultaneously with the formation of the plurality of lenses.

16. The method according to claim 14, wherein
the plurality of lenses are formed on the substrate prior to the flow restricting structure being formed on the substrate.

17. The method according to claim 14, wherein
Flow restricting dam structure is a plurality of dummy lenses formed on the outer periphery of the plurality of lenses.

18. The method according to claim 17, wherein
the plurality of lenses are formed on the substrate and the flow restricting structure is formed simultaneously with the formation of the plurality of lenses.

19. The method according to claim 14, wherein
the flow restricting structure is a wall that surrounds the outer periphery of the plurality of lenses.

20. The image forming device according to claim 19, wherein
the wall extends to a periphery of the substrate.

21. The image forming device according to claim 19, wherein
the wall is tapered at an acute angle.
